(19) United States
(12) Patent Application Publication
(10) Pub. No.: US 2026/0057052 A1
(43) Pub. Date: Feb. 26, 2026

(54) System and Method for Authenticating Users Based on Reflectance and Temporality Associated with Emitted Dynamic Illumination Patterns

(71) Applicant: Bank of America Corporation, Charlotte, NC (US)

(72) Inventors: Sandeep Kumar Chauhan, Hyderabad (IN); Saurabh Arora, Gurugram (IN); Aditya Venu Pillai, Chennai (IN); Ishita Singh, Bharatpur (IN); Divya S. Kumar, New Delhi (IN); Nekamath Fermetha Sheik Abdul Kadar Hakkeem, Chennai (IN); Sarah Colaco, Mumbai (IN); Chitra Muthumani, Mumbai (IN); Shivani Joshi, Hyderabad (IN)

(21) Appl. No.: 18/812,139

(22) Filed: Aug. 22, 2024

(51) Int. Cl. G06F 21/32; G06F 40/40; G06V 10/145; G06V 10/60; G06V 10/62; G06V 40/10

(52) U.S. Cl. CPC G06F 21/32; G06F 40/40; G06V 10/145; G06V 10/60; G06V 10/62; G06V 40/10

(57) ABSTRACT

A system includes a memory configured to store user image data associated with a user. The system includes a processor operably coupled to the memory and configured to access the user image data, in which the user image data is captured in conjunction with a video exchange session. The processor is configured to cause a software application to display a sequence of temporal-based dynamic illumination patterns, and further identify a set of pixel values to be projected onto the user during display of the sequence of temporal-based dynamic illumination patterns. The processor is configured to execute a vision-based machine-learning model trained to identify whether the user image data corresponds to authorized or unauthorized user image data based on the sequence of temporal-based dynamic illumination patterns and a video capture of a set of pixel values projected onto the user during display of the sequence of temporal-based dynamic illumination patterns.

### TECHNICAL FIELD

The present disclosure relates generally to computing security, and, more specifically, to a system and method for authenticating users based on reflectance and temporality associated with emitted dynamic illumination patterns.

### BACKGROUND

Certain web-based environments may include data being exchanged and stored across any number of computing systems and databases. For example, the data may include various user data or service data that may be stored to databases associated with respective entities, and that user data or service data may be exchanged between various centralized or decentralized servers and various computing systems for servicing end users. However, such web-based environments may be sometimes susceptible to infiltration by adversarial users or cyber-attackers.

### SUMMARY

The system and methods implemented by the system as disclosed in the present disclosure provide technical solutions to the technical problems discussed above by providing systems and methods for authenticating users based on reflectance and temporality associated with emitted dynamic illumination patterns. The disclosed system and methods provide several practical applications and technical advantages. Specifically, the present embodiments improve the security, reliability, and maintainability of software applications, systems, and sensitive user data, as well as the one or more processors and memory on which the software applications, systems, and sensitive user data may be executed and stored by providing a threat detection system that utilizes a lightweight vision-based machine-learning model trained to identify whether user image data captured during a live video exchange session (e.g., a videoconference, a videotelephony exchange, a video stream) corresponds to authorized user image data or unauthorized user image data.

For example, based on a sequence of temporal-based dynamic illumination patterns and a video capture of a set of pixel values projected onto a user during a live video exchange session, the lightweight vision-based machine-learning model may determine (in real-time or near real-time) whether to allow or restrict further access to sensitive user data and/or to execute or terminate a requested interaction when the lightweight vision-based machine-learning model identifies that an image of a user displayed during the live video exchange session (e.g., deepfake image of the user) does not correspond to a “live” and “real” user preauthorized to have access to sensitive user data and/or to execute a requested interaction.

Thus, the present embodiments may identify, isolate, and preempt potential threats, adversarial attacks, cyberattacks, data breaches, or other security vulnerabilities that may be associated with software applications, systems, and sensitive user data. Specifically, by identifying in real-time or near real-time deepfake images during live video exchange sessions, the present embodiments may identify real-time or near real-time threats and actively reconfigure the software application, system, or sensitive user data to which the “live” and “real” user previously had access to prevent a potential data leak or other systemic vulnerability with respect to the software application, system, or sensitive user data.

Moreover, by training and utilizing a lightweight vision-based machine-learning model, such as a lightweight vision language model (VLM) or other similar lightweight multimodal language model (MLM), to determine whether an image of a user displayed during a live video exchange session corresponds to a “live” and “real” user preauthorized to have access to sensitive user data, the present embodiments may reduce processor execution times, memory storage requirements, and processor workloads of the processor and memory on which the lightweight vision-based machine-learning model is trained and executed. Indeed, the lightweight vision-based machine-learning model as presently disclosed herein may be trained utilizing a single graphic processing unit (GPU) and executed utilizing a single GPU or a single central processing unit (CPU) as opposed to large and more complex hardware artificial-intelligence (AI) accelerators suitable for training and executing large language models (LLMs) and multimodal large language models (MLLMs).

For example, in one embodiment, the lightweight vision-based machine-learning model as presently disclosed herein may include a 2.8 billion (2.8 B) parameter vision language model (VLM), a 7.0 B parameter VLM, or a 10.0 B parameter VLM, which may be each trained and executed utilizing a single GPU as opposed to large LLMs and MLLMs having 20-100 billion parameters and being suited for training and execution on large numbers of compute-intensive and complex hardware AI accelerators.

The present embodiments are directed to systems and methods for authenticating users based on reflectance and temporality associated with emitted dynamic illumination patterns. In particular embodiments, a system includes a memory configured to store user profile data associated with at least one user of a plurality of users and user image data associated with the least one user. In particular embodiments, the system further includes one or more processors operably coupled to the memory.

In particular embodiments, the one or more processors may be configured to access the user image data associated with the at least one user. For example, in particular embodiments, the user image data is captured in relation to a video exchange session regarding the user profile data. In one embodiment, the video exchange session may be conducted electronically between the at least one user and a preauthorized user. In one embodiment, the user image data is captured in relation to a live video exchange session conducted electronically between the at least one user and the preauthorized user.

In particular embodiments, the one or more processors may be further configured to cause a software application executing on a user computing device associated with the at least one user to display a sequence of temporal-based dynamic illumination patterns during the video exchange session. In particular embodiments, the one or more processors may be further configured to identify, based at least in part on the sequence of temporal-based dynamic illumination patterns and the user image data, a set of pixel values to be projected onto the at least one user during display of the sequence of temporal-based dynamic illumination patterns. For example, in particular embodiments, the set of pixel values to be projected onto the at least one user during display of the sequence of temporal-based dynamic illumination patterns may include a set of colors to be projected onto one or more a face of the at least one user or a body of the at least one user.

In particular embodiments, the one or more processors may be further configured to execute one or more vision-based machine-learning models trained to identify whether the user image data corresponds to authorized user image data or unauthorized user image data based at least in part on the sequence of temporal-based dynamic illumination patterns and a video capture of the set of pixel values projected onto the at least one user during display of the sequence of temporal-based dynamic illumination patterns.

In particular embodiments, in response to the set of pixel values being projected onto the at least one user during display of the sequence of temporal-based dynamic illumination patterns, the one or more processors may be further configured to receive a reflectance of the set of pixel values projected onto the at least one user and execute the one or more vision-based machine-learning models further trained to: 1) perform a frame-by-frame comparison of the reflectance of the set of pixel values projected onto the at least one user and the video capture of the set of pixel values projected onto the at least one user to identify an amount of deviation therebetween and 2) classify the user image data as corresponding to the authorized user image data or the unauthorized user image data based at least in part on the amount of deviation.

In particular embodiments, the one or more processors may be further configured to execute the one or more vision-based machine-learning models further trained to classify the user image data as corresponding to the authorized user image data or the unauthorized user image data based at least in part on whether the amount of deviation satisfies a predetermined threshold. In particular embodiments, the one or more vision-based machine-learning models may include one or more of a multimodal language model (MLM) or a multimodal large language model (MLLM). In particular embodiments, the one or more vision-based machine-learning models may include one or more of a vision language model (VLM), a vision transformer (ViT), a vision encoder, or a video language model (VideoLM). In particular embodiments, in response to determining that the user image data corresponds to unauthorized user image data, the one or more processors may be further configured to cause the software application to restrict further access to the user profile data.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a system of a server and host computing system and network, in accordance with certain aspects of the present disclosure;

FIG. 2 illustrates a workflow diagram of an embodiment of a video exchange session threat detection system for authenticating users based on reflectance and temporality associated with emitted dynamic illumination patterns, in accordance with one or more embodiments of the present disclosure; and

FIG. 3 illustrates a flowchart of an example method for authenticating users based on reflectance and temporality associated with emitted dynamic illumination patterns, in accordance with one or more embodiments of the present disclosure.

### DETAILED DESCRIPTION

### Example System

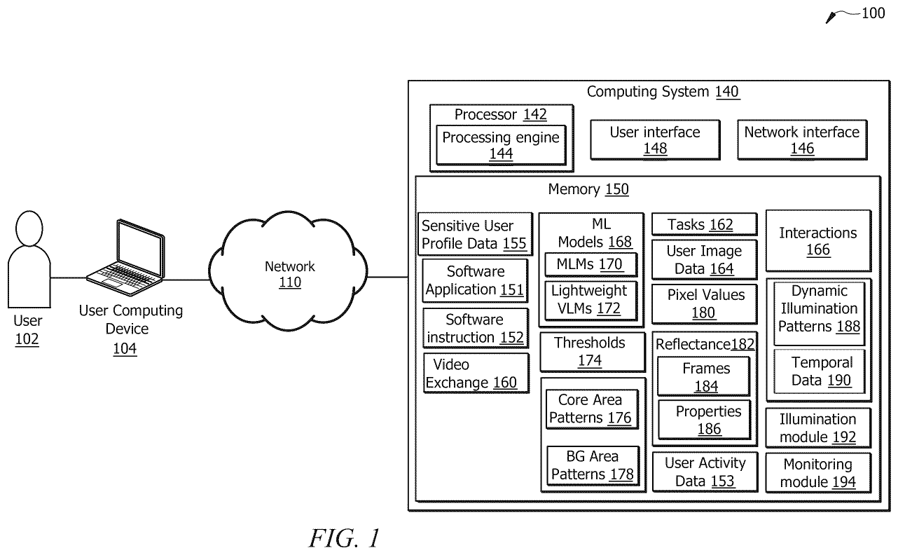

FIG. 1 is a block diagram illustrating a system 100 that includes a computing system 140 communicatively coupled to a computing device 104 by way of a network 106. In general, the computing system 140 is configured to authenticate a user 102 operating computing device 104 based on reflectance and temporality associated with emitted dynamic illumination patterns in conjunction with other components of system 100.

In particular embodiments, the user 102 may include any user external to an institution, an organization, or an entity that may be preauthorized by the user 102 to hold sensitive user profile data 155 associated with the user 102. In some embodiments, the sensitive user profile data 155 may be a subset of a large aggregate of user profile data that may be associated with a large number of users external to the institution, the organization, or the entity. The network 110 enables communications among components of the system 100. In other embodiments, the system 100 may not have all of the components listed and/or may have other elements instead of, or in addition to, those listed above.

In particular embodiments, the computing system 140 may include a processor 142 in signal communication with a memory 150. The memory 150 stores software instructions 152 that when executed by the processor 142, cause the processor 142 to perform one or more functions described herein. For example, when the software instructions 152 are executed, the processor 142 executes a processing engine 144 to access the user image data 164 associated with the user 102, in which the user image data 164 is captured in relation to a video exchange session regarding the sensitive user profile data 155. The processor 142 further executes the processing engine 144 to cause an instance of a software application 151 executing on the user computing device 104 to display a sequence dynamic illumination patterns 188 associated with temporal data 190 during the video exchange session.

In particular embodiments, the processor 142 further executes the processing engine 144 to one or more machine-learning models 168 trained to identify whether user image data 164 corresponds to authorized user image data 164 or unauthorized user image data 164 based on the sequence dynamic illumination patterns 188 and associated temporal data 190 and a video capture of a set of pixel values 180 projected onto the user 102 during display of the sequence dynamic illumination patterns 188 and associated temporal data 190.

The system 100 may be configured as shown, or in any other configuration. In accordance with the presently disclosed embodiments, the computing system 140 may include a centralized or decentralized server of an institution or organization suitable for hosting and servicing a large number of external users, as well as internal users, such as the user 102 while utilizing the user computing device 104.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Computing System

In particular embodiments, the computing system 140 is generally any computing device that is configured to process data and communicate with computing devices (e.g., user computing device 104), databases, systems, etc., via the network 110. The computing system 140 is generally configured to oversee operations of the processing engine 144. In particular embodiments, the computing system 140 may include the processor 142 in signal communication with a network interface 146, a user interface 148, and memory 150. The computing system 140 may be configured as shown, or in any other configuration.

The processor 142 may include one or more processors operably coupled to the memory 150. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 142 may be a programmable logic device, a microcontroller, a microprocessor, or any suitable combination of the preceding. The processor 142 is communicatively coupled to and in signal communication with the network interface 146, user interface 148, and memory 150. The one or more processors are configured to process data and may be implemented in hardware or software.

For example, the processor 142 may be 8-bit, 16-bit, 32-bit, 64-bit or of any other suitable architecture. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 152 to implement the functions disclosed herein, such as some or all of those described with respect to FIGS. 1-3. In some embodiments, the function described herein is implemented using logic units, FPGAs, ASICs, DSPs, or any other suitable hardware or electronic circuitry.

The network interface 146 is configured to enable wired and/or wireless communications (e.g., via the network 110). The network interface 146 is configured to communicate data between the computing system 140 and other network devices, systems, or domain(s). For example, the network interface 146 may comprise a WIFI interface, a local area network (LAN) interface, a wide area network (WAN) interface, a modem, a switch, or a router. The processor 142 is configured to send and receive data using the network interface 146. The network interface 146 may be configured to use any suitable type of communication protocol.

The memory 150 may be volatile or non-volatile and may include a read-only memory (ROM), random-access memory (RAM), ternary content-addressable memory (TCAM), dynamic random-access memory (DRAM), and static random-access memory (SRAM), or other non-transitory computer-readable medium. Memory 150 may be implemented using one or more disks, tape drives, solid-state drives, and/or the like. Memory 150 is operable to store the software instructions 152, which may be executed by the processor 142 in accordance with the presently disclosed embodiments. The memory 150 may also store a software application 151 that may be hosted on the computing system 140, such that the computing system 140 may service respective instances of the software application 151 that may be executing on respective user computing devices, such as user computing device 104. In one embodiment, the software application 151 may include a large software application suitable for hosting and servicing thousands or millions of individual users and that may also interact via the network 106 with the computing system 140.

### Processing Engine

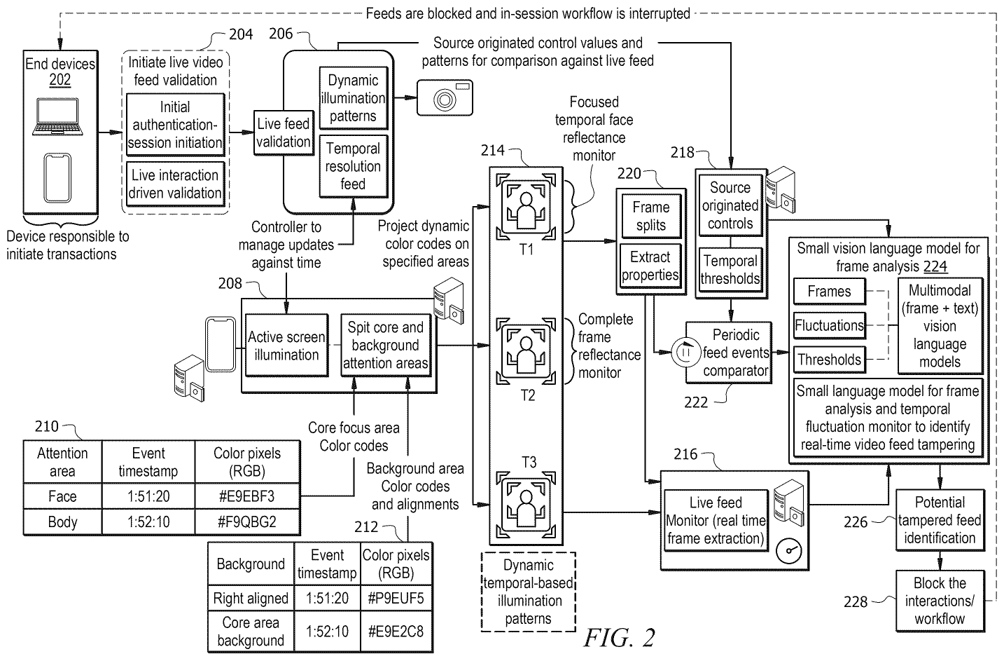

Processing engine 144 may be implemented by the processor 142 executing the software instructions 152, and is generally configured to authenticating users 102 based on reflectance and temporality associated with emitted dynamic illumination patterns. In particular embodiments, as will be discussed in greater detail below with respect to FIG. 2, the processing engine 144 may receive and/or cause to be captured by the user computing device 104 one or more of user activity data 153, video exchange data 160, user image data 164, thresholds 174, reflectance 182, image frames 184, extracted image properties 186, or interactions 166. In particular embodiments, as will be further discussed below with respect to FIG. 2, the processing engine 144 may generate one or more of core area illumination patterns 176, background area illumination patterns 178, sets of pixel values 180, dynamic illumination patterns 188, or temporal data 190.

In particular embodiments, the processing engine 144 may execute the one or more machine-learning models 168 to perform various machine-learning tasks 162. In one embodiment, the one or more machine-learning models 168 may include one or more of a language model (LM), a large language model (LLM), one or more transformer-based machine-learning models, or one or more sequence-to-sequence (Seq2Sec) models. In another embodiment, the one or more machine-learning models 168 may include one or more multimodal language models (MLMs) (e.g., MLMs 170), one or more multimodal large language models (MLLMs), one or more lightweight vision language models (VLMs) 172, one or more vision transformers (ViTs), one or more vision encoders, one or more video language models (VideoLMs), or other similar vision-based machine-learning model.

For example, in particular embodiments, the one or more lightweight VLMs 172 may include a “small” or lightweight VLM, such as TinyGPT-V, Florence-2, LLaVA1.5, or other similar lightweight or “small” VLM that may be pretrained, trained, and/or fine-tuned to identify whether user image data 164 captured during a live video exchange session (e.g., a videoconference, a videotelephony exchange, a video stream) corresponds to authorized user image data 164 or unauthorized user image data 164 in accordance with the presently disclosed embodiments. In one embodiment, the one or more lightweight VLMs 172 may include a 2.8 billion (2.8 B) parameter VLM, a 7.0 B parameter VLM, or a 10.0 B parameter VLM, which may be each trained and executed utilizing a single GPU as opposed to large LLMs and MLLMs having 20-100 billion parameters and being suited for training and execution on large numbers of compute-intensive and complex hardware AI accelerators.

For example, as will be discussed in greater detail below with respect to FIG. 2, based on a sequence of temporal-based dynamic illumination patterns and a video capture of a set of pixel values projected onto a user during a live video exchange session, the one or more lightweight VLMs 172 may determine (in real-time or near real-time) whether to allow or restrict further access to sensitive user data and/or to execute or terminate one or more requested interactions 166 when the one or more lightweight VLMs 172 identifies that an image of the user 102 displayed during the live video exchange session does not correspond to the “live” and “real-life” user 102 preauthorized to have access to sensitive user data 155 and/or to execute one or mor requested interactions 166.

### Authenticating Users Based on Reflectance and Temporality Associated With Emitted Dynamic Illumination Patterns

Embodiments of the present disclosure discuss techniques for authenticating users based on reflectance and temporality associated with emitted dynamic illumination patterns.

FIG. 2 illustrates a workflow diagram of an embodiment of a video exchange session threat detection system 200 for authenticating users based on reflectance and temporality associated with emitted dynamic illumination patterns, in accordance with certain aspects of the present disclosure. In particular embodiments, the workflow of the video exchange session threat detection system 200 may be performed utilizing the computing system 140 as described above with respect to FIG. 1. As depicted, the workflow of the video exchange session threat detection system 200 may begin with an instance of the software application 151 being launched and executed on a user computing device 202. For example, in particular embodiments, the software application 151 may be hosted on the computing system 140 and may service any number of instances of the software application 151 that may be executed on end user computer devices, such as user computing device 202. The user computing device 202 may be identical to the user computing device 104 as discussed above with respect to FIG. 1.

In particular embodiments, the workflow of the video exchange session threat detection system 200 may then proceed with user computing device 202 executing a live interaction driven validation subprocess 204. For example, in particular embodiments, upon the instance of the software application 151 executing on the user computing device 202 being launched, the user 102 may then perform an initial authentication subprocess, which may include inputting one or more of a password, a biometric input, a facial image, a personal identification number (PIN), or other identification data by which the user 102 of the user computing device 202 may be initially authenticated.

In particular embodiments, the user 102 of the computing device 202 may then request to execute one or more interactions 166 by way of a video exchange session. For example, a video exchange session may include a live video-streaming conference (e.g., a videoconference, a videotelephony exchange, a video stream) may be conducted between the user 102 (utilizing the instance of the software application 151 executing on the user computer device 202) and a preauthorized user (e.g., customer service associate, customer service representative) preauthorized to access sensitive user profile data 155 that may be associated with the user 102.

In particular embodiments, the user 102 may request (utilizing the instance of the software application 151 executing on the user computer device 202) to execute any of various interactions 166 during a live video exchange session. For example, the user 102 may request (utilizing the instance of the software application 151 executing on the user computer device 202) to access and view sensitive user profile data 155, to transfer data units between different sensitive user profiles, to open one or more new sensitive user profiles, to link a sensitive user profile to a third-party user profile associated with the same user 102, to instantiate a new or an updated physical card or virtual card that may be associated with a sensitive user profile associated with the user 102, and/or to finalize the execution of a particular interaction 166.

In particular embodiments, the workflow of the video exchange session threat detection system 200 may then proceed with an illumination module (e.g., illumination module 192) executing dynamic temporal-based illumination subprocesses 206 and 208. For example, in particular embodiments, the illumination module (e.g., illumination module 192) may generate dynamic illumination patterns and temporal data associated therewith to be displayed during the ongoing video exchange session via the instance of the software application 151 executing on the user computer device 202

In one embodiment, as part of the dynamic temporal-based illumination subprocesses 206 and 208, the illumination module (e.g., illumination module 192) may cause the dynamic illumination patterns to be split into core area illumination patterns 176 (e.g., foreground illumination patterns) and background area illumination patterns 178. For example, as illustrated by tables 210 and 212, the core area illumination patterns 176 (e.g., foreground illumination patterns) and background area illumination patterns 178 may each include a set of pixel values 180 (e.g., representing different pixel colors) and associated temporal data 190 (e.g., timestamps) to be sequentially displayed and projected onto the user 102 at prespecified points in time during the ongoing video exchange session.

In particular embodiments, the workflow of the video exchange session threat detection system 200 may then proceed with the illumination module (e.g., illumination module 192) executing a dynamic color projection subprocess 214. For example, in one embodiment, the illumination module (e.g., illumination module 192) may cause the instance of the software application 151 executing on the user computing device 202 to project the core area illumination patterns 176 onto a face of the user 102 or onto a body of the user 102 during the ongoing video exchange session. In one example, the illumination module (e.g., illumination module 192) may cause the instance of the software application 151 executing on the user computing device 202 to project a sequence of different pixel colors (e.g., yellow at time T₁, blue at time T₂, green at time T₃, and so forth) during the ongoing video exchange session.

Concurrently, the illumination module (e.g., illumination module 192) may further cause the instance of the software application 151 executing on the user computing device 202 to project the background area illumination patterns 178 into background areas not corresponding to the user 102. In one example, the illumination module (e.g., illumination module 192) may cause the instance of the software application 151 executing on the user computing device 202 to project a sequence of different pixel grayscale colors (e.g., brightest pixels at time T₁, dimmer pixels at time T₂, darkest pixels at time T₃, and so forth).

In particular embodiments, the workflow of the video exchange session threat detection system 200 may then proceed with a monitoring module (e.g., monitoring module 194) executing a live video capture subprocess 216, and a dynamic illumination patterns and temporal data extraction subprocess 218, and a frame extraction and analysis subprocess 220. For example, in particular embodiments, as part of the live video capture subprocess 216, the monitoring module (e.g., monitoring module 194) may receive and analyze a live video capture of the user 102 during the ongoing video exchange session.

Similarly, as part of the dynamic illumination patterns and temporal data extraction subprocess 218, the monitoring module (e.g., monitoring module 194) may receive and store the set of pixel values 180 (e.g., representing different pixel colors) and associated temporal data 190 (e.g., timestamps) as displayed and projected onto the user 102. Specifically, the monitoring module (e.g., monitoring module 194) may receive and store the set of pixel values 180 (e.g., representing different pixel colors) as displayed and projected onto the user 102, the associated temporal data 190 (e.g., timestamps), and one or more predetermined thresholds (e.g., thresholds 174), all of which may be utilized for comparison against the live video capture of the user 102 during the ongoing video exchange session.

In particular embodiments, as part of the frame extraction and analysis subprocess 220, the monitoring module (e.g., monitoring module 194) may cause the instance of the software application 151 executing on the user computing device 202 to capture by way of a camera on the user computing device 202 a reflectance 182 of the core area illumination patterns 176 projected onto the face of the user 102 or onto the body of the user 102 and/or the background area illumination patterns 178 projected into background areas not corresponding to the user 102.

For example, in particular embodiments, the monitoring module (e.g., monitoring module 194) may leverage the fact that the live video capture of the user 102 during the ongoing video exchange session may itself include a series of frames 184 interwoven with temporal information, and may be thus suitably compared against the set of pixel values 180 (e.g., representing different pixel colors) as displayed and projected onto the user 102, the associated temporal data 190 (e.g., timestamps), and one or more predetermined thresholds (e.g., thresholds 174).

That is, as will be discussed in greater detail below, a lightweight VLM (e.g., one or more lightweight VLMs 172) may be utilized to generate a prediction of whether the user 102 is authorized or unauthorized to continue accessing sensitive user profile data 155 and/or to execute one or more interactions 166 based on a comparison of the pixel values and pixel properties as extracted from the individual frames 184 of the live video capture of the user 102 against the previously generated set of pixel values 180 (e.g., representing different pixel colors) as displayed and projected onto the user 102, the associated temporal data 190 (e.g., timestamps), and the one or more predetermined thresholds (e.g., thresholds 174).

Specifically, the lightweight VLM (e.g., one or more lightweight VLMs 172) may be utilized to identify a deviation between the of the pixel values and pixel coordinates extracted from the individual frames 184 of the live video capture of the user 102 and the previously generated set of pixel values 180 (e.g., representing different pixel colors) and the associated temporal data 190 (e.g., timestamps). That is, in some embodiments, the lightweight VLM (e.g., one or more lightweight VLMs 172) may generate a deviation score of “0.0” when the of the pixel values and pixel coordinates extracted from the individual frames of the live video capture of the user 102 matches to the previously generated set of pixel values 180 (e.g., representing different pixel colors) and the associated temporal data 190 (e.g., timestamps).

On the other hand, the lightweight VLM (e.g., one or more lightweight VLMs 172) may generate a deviation score of “1.0” when the of the pixel values and pixel coordinates extracted from the individual frames 184 of the live video capture of the user 102 does not match to the previously generated set of pixel values 180 (e.g., representing different pixel colors) and the associated temporal data 190 (e.g., timestamps). In one embodiment, the one or more predetermined thresholds (e.g., thresholds 174) may be utilized to define a configurable amount of deviation that may be determined acceptable for identifying a match. For example, in one embodiment, a deviation score of “0.0”; “0.1”; “0.2”, or “0.3” may indicate a match while a deviation score of “0.7”; “0.8”; “0.9”, or “1.0”may indicate a non-match.

In particular embodiments, the workflow of the video exchange session threat detection system 200 may then proceed with the lightweight VLM (e.g., one or more lightweight VLMs 172) executing a vision-based machine-learning model authentication subprocess 224. For example, as generally noted above, the lightweight VLM (e.g., one or more lightweight VLMs 172) may be utilized to identify a deviation between the of the pixel values and pixel coordinates extracted from the individual frames 184 of the live video capture of the user 102 during the ongoing video exchange session and the previously generated set of pixel values (e.g., representing different pixel colors) and the associated temporal data (e.g., timestamps).

In particular embodiments, the lightweight VLM (e.g., one or more lightweight VLMs 172) may include, for example, TinyGPT-V, Florence-2, LLaVA1.5, or other similar lightweight or “small” VLM that may be pretrained, trained, and/or fine-tuned to identify to a deviation between the of the pixel values and pixel coordinates extracted from the individual frames of the live video capture of the user 102 during the ongoing video exchange session and the previously generated set of pixel values (e.g., representing different pixel colors) and the associated temporal data (e.g., timestamps).

Specifically, the lightweight VLM (e.g., one or more lightweight VLMs 172) may be pretrained, trained, and/or fine-tuned to perform a frame-by-frame analysis of the live video capture of the user 102. Based on the identified deviation from the previously generated set of pixel values 180 (e.g., representing different pixel colors) and the associated temporal data 190 (e.g., timestamps), the lightweight VLM (e.g., one or more lightweight VLMs 172) may generate an output of whether the user 102 is “authorized” or “unauthorized” to continue accessing sensitive user profile data 155 and/or to execute one or more interactions 166 (illustrated by subprocesses 216 and 218). In this way, the present embodiments may leverage the strong reasoning ability of the lightweight VLM (e.g., one or more lightweight VLMs 172) to generate simple per-frame natural language descriptions (e.g., “match”; “non-match”; “authorized”; “unauthorized) of the inputted image frames 184 of the live video capture of the user 102.

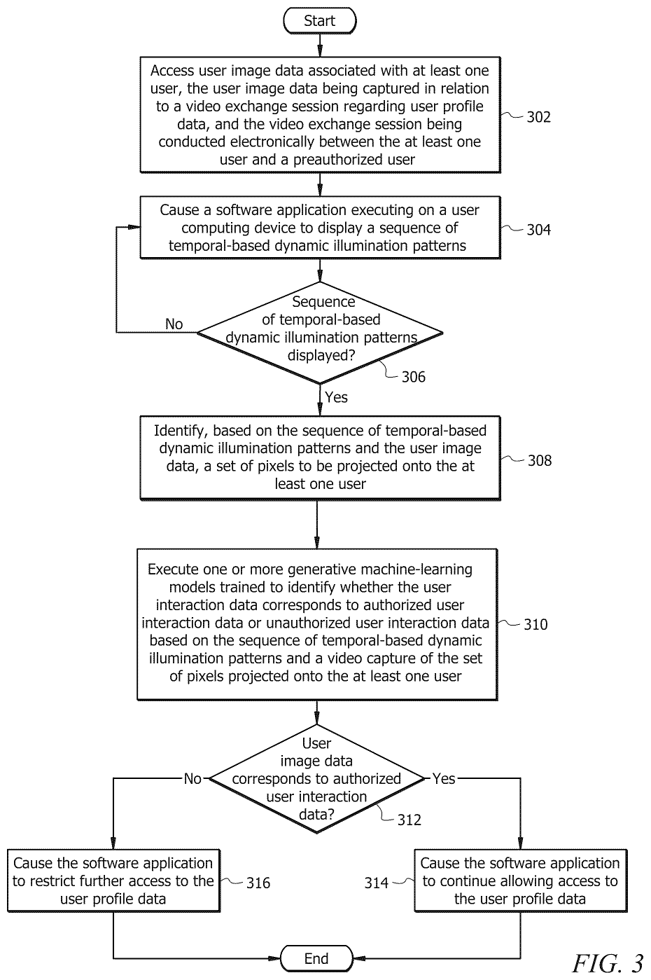

FIG. 3 illustrates a flowchart of an example method 300 for authenticating users based on reflectance and temporality associated with emitted dynamic illumination patterns, in accordance with one or more embodiments of the present disclosure. The method 300 may be performed utilizing the computing system 140 as described above with respect to FIG. 1. The method 300 may begin at block 302 with the computing system 140 accessing user image data 164 associated with at least one user 102, in which the user image data 164 is captured in relation to a video exchange session regarding user profile data 155 and the video exchange session is conducted electronically between the at least one user 102 and a preauthorized user.

The method 300 may then continue at block 304 with the computing system 140 causing a software application (e.g., an instance of the software application 151) executing on a user computing device (e.g., user computing device 202) to display a sequence of temporal-based dynamic illumination patterns. In particular embodiments, the method 300 may then continue at decision 306 with the computing system 140 confirming whether the sequence of temporal-based dynamic illumination patterns has been displayed. For example, in response to confirming that the sequence of temporal-based dynamic illumination patterns has not been displayed by the software application (e.g., an instance of the software application 151) executing on a user computing device (e.g., user computing device 202), the method 300 may return to block 304 as discussed above.

On the other hand, in response to confirming that the sequence of temporal-based dynamic illumination patterns has been displayed by the software application (e.g., an instance of the software application 151) executing on a user computing device (e.g., user computing device 202), the method 300 may then continue at block 308 with the computing system 140 identifying, based on the sequence of temporal-based dynamic illumination patterns and the user image data, a set of pixel values to be projected onto the at least one user (e.g., user 102) during display of the sequence of temporal-based dynamic illumination patterns.

In particular embodiments, the method 300 may then continue at block 310 with the computing system 140 executing one or more vision-based machine-learning models 168 (e.g., one or more lightweight VLMs 172) trained to identify whether the user image data 164 corresponds to authorized user image data 164 or unauthorized user image data 164 based on the sequence of temporal-based dynamic illumination patterns and a video capture of the set of pixel values projected onto the at least one user (e.g., user 102) during display of the sequence of temporal-based dynamic illumination patterns.

In particular embodiments, the method 300 may then continue at decision 312 with the computing system 140 confirming whether the user image data 164 corresponds to authorized user image data 164 or unauthorized user image data 164. In particular embodiments, in response to the computing system 140 confirming that the user image data 164 corresponds to authorized user image data 164, the method 300 may then continue at block 314 with the computing system 140 causing the software application (e.g., an instance of the software application 151) executing on the user computing device (e.g., user computing device 202) to continue allowing access to the user profile data 155 and/or allowing execution of one or more interactions 166.

For example, in response to confirming that the user image data 164 corresponds to authorized user image data 164, the software application (e.g., an instance of the software application 151) executing on the user computing device (e.g., user computing device 202) may continue to display user profile data 155 and continue to allow the user 102 to interact with the user profile data 155 and/or to complete an execution of one or more interactions 166. Other hand, in response to the computing system 140 confirming that the user image data 164 corresponds to unauthorized user image data 164, the method 300 may then continue at block 316 with the computing system 140 causing the software application (e.g., an instance of the software application 151) executing on the user computing device (e.g., user computing device 202) to restrict further access to the user profile data 155.

For example, in response to confirming that the user image data user image data 164 corresponds to unauthorized user image data user image data 164, the software application (e.g., an instance of the software application 151) executing on the user computing device (e.g., user computing device 202) may forgo displaying the user profile data 155 and restrict any further access to the user profile data 155 and/or restrict execution of one or more interactions 166. In one embodiment, the software application (e.g., an instance of the software application 151) executing on the user computing device (e.g., user computing device 202) may mask the user profile data 155 or perform one or more other data obfuscation processes suitable for preventing or reducing further access to the user profile data 155 and/or restricting any execution of one or more interactions 166.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store user profile data associated with at least one user of a plurality of users and user image data associated with the least one user; and
one or more processors operably coupled to the memory and configured to:
access the user image data associated with the at least one user, the user image data being captured in relation to a video exchange session regarding the user profile data, wherein the video exchange session is conducted electronically between the at least one user and a preauthorized user;
cause a software application executing on a user computing device associated with the at least one user to display a sequence of temporal-based dynamic illumination patterns during the video exchange session;
identify, based at least in part on the sequence of temporal-based dynamic illumination patterns and the user image data, a set of pixel values to be projected onto the at least one user during display of the sequence of temporal-based dynamic illumination patterns;
execute one or more vision-based machine-learning models trained to identify whether the user image data corresponds to authorized user image data or unauthorized user image data based at least in part on the sequence of temporal-based dynamic illumination patterns and a video capture of the set of pixel values projected onto the at least one user during display of the sequence of temporal-based dynamic illumination patterns; and
in response to determining that the user image data corresponds to unauthorized user image data, cause the software application to restrict further access to the user profile data.

2. The system of claim 1, wherein the user image data is captured in conjunction with a live video exchange session conducted electronically between the at least one user and the preauthorized user.

3. The system of claim 1, wherein the set of pixel values to be projected onto the at least one user during display of the sequence of temporal-based dynamic illumination patterns comprises a set of colors to be projected onto one or more of a face of the at least one user or a body of the at least one user.

4. The system of claim 1, wherein the one or more processors are further configured to:
in response to the set of pixel values being projected onto the at least one user during display of the sequence of temporal-based dynamic illumination patterns, receive a reflectance of the set of pixel values projected onto the at least one user; and
execute the one or more vision-based machine-learning models further trained to: 1) perform a frame-by-frame comparison of the reflectance of the set of pixel values projected onto the at least one user and the video capture of the set of pixel values projected onto the at least one user to identify an amount of deviation therebetween and 2) classify the user image data as corresponding to the authorized user image data or the unauthorized user image data based at least in part on the amount of deviation.

5. The system of claim 4, wherein the one or more processors are further configured to:
execute the one or more vision-based machine-learning models further trained to classify the user image data as corresponding to the authorized user image data or the unauthorized user image data based at least in part on whether the amount of deviation satisfies a predetermined threshold.

6. The system of claim 1, wherein the one or more vision-based machine-learning models comprises one or more of a multimodal language model (MLM) or a multimodal large language model (MLLM).

7. The system of claim 1, wherein the one or more vision-based machine-learning models comprises one or more of a vision language model (VLM), a vision transformer (ViT), a vision encoder, or a video language model (VideoLM).

8. A method, comprising:
accessing user image data associated with at least one user of a plurality of users, the user image data being captured in relation to a video exchange session regarding user profile data associated with the at least one user, and the video exchange session being conducted electronically between the at least one user and a preauthorized user;
causing a software application executing on a user computing device to display a sequence of temporal-based dynamic illumination patterns during the video exchange session;
identifying, based at least in part on the sequence of temporal-based dynamic illumination patterns and the user image data, a set of pixel values to be projected onto the at least one user during display of the sequence of temporal-based dynamic illumination patterns;
executing one or more vision-based machine-learning models trained to identify whether the user image data corresponds to authorized user image data or unauthorized user image data based at least in part on the sequence of temporal-based dynamic illumination patterns and a video capture of the set of pixel values projected onto the at least one user during display of the sequence of temporal-based dynamic illumination patterns; and
in response to determining that the user image data corresponds to unauthorized user image data, causing the software application to restrict further access to the user profile data.

9. The method of claim 8, wherein the user image data is captured in conjunction with a live video exchange session conducted electronically between the at least one user and the preauthorized user.

10. The method of claim 8, wherein the set of pixel values to be projected onto the at least one user during display of the sequence of temporal-based dynamic illumination patterns comprises a set of colors to be projected onto one or more a face of the at least one user or a body of the at least one user.

11. The method of claim 8, further comprising:
in response to the set of pixel values being projected onto the at least one user during display of the sequence of temporal-based dynamic illumination patterns, receiving a reflectance of the set of pixel values projected onto the at least one user; and
executing the one or more vision-based machine-learning models further trained to: 1) perform a frame-by-frame comparison of the reflectance of the set of pixel values projected onto the at least one user and the video capture of the set of pixel values projected onto the at least one user to identify an amount of deviation therebetween and 2) classify the user image data as corresponding to the authorized user image data or the unauthorized user image data based at least in part on the amount of deviation.

12. The method of claim 11, further comprising:
executing the one or more vision-based machine-learning models further trained to classify the user image data as corresponding to the authorized user image data or the unauthorized user image data based at least in part on whether the amount of deviation satisfies a predetermined threshold.

13. The method of claim 8, wherein the one or more vision-based machine-learning model comprises one or more of a multimodal language model (MLM) or a multimodal large language model (MLLM).

14. The method of claim 8, wherein the one or more vision-based machine-learning model comprises one or more of a vision language model (VLM),, a vision transformer (ViT), a vision encoder, or a video language model (VideoLM).

15. A non-transitory computer-readable medium storing instructions that, when executed by one or more processors, cause the one or more processors to:
access user image data associated with at least one user of a plurality of users, the user image data being captured in relation to a video exchange session regarding user profile data associated with the at least one user, and the video exchange session being conducted electronically between the at least one user and a preauthorized user;
cause a software application executing on a user computing device to display a sequence of temporal-based dynamic illumination patterns during the video exchange session;
identifying, based at least in part on the sequence of temporal-based dynamic illumination patterns and the user image data, a set of pixel values to be projected onto the at least one user during display of the sequence of temporal-based dynamic illumination patterns;
execute one or more vision-based machine-learning models trained to identify whether the user image data corresponds to authorized user image data or unauthorized user image data based at least in part on the sequence of temporal-based dynamic illumination patterns and a video capture of the set of pixel values projected onto the at least one user during display of the sequence of temporal-based dynamic illumination patterns; and
in response to determining that the user image data corresponds to unauthorized user image data, cause the software application to restrict further access to the user profile data.

16. The non-transitory computer-readable medium of claim 15, wherein the user image data is captured in conjunction with a live video exchange session conducted electronically between the at least one user and the preauthorized user.

17. The non-transitory computer-readable medium of claim 15, wherein the set of pixel values to be projected onto the at least one user during display of the sequence of temporal-based dynamic illumination patterns comprises a set of colors to be projected onto one or more a face of the at least one user or a body of the at least one user.

18. The non-transitory computer-readable medium of claim 15, wherein the instructions further cause the one or more processors to:
in response to the set of pixel values being projected onto the at least one user during display of the sequence of temporal-based dynamic illumination patterns, receive a reflectance of the set of pixel values projected onto the at least one user; and
execute the one or more vision-based machine-learning models further trained to: 1) perform a frame-by-frame comparison of the reflectance of the set of pixel values projected onto the at least one user and the video capture of the set of pixel values projected onto the at least one user to identify an amount of deviation therebetween and 2) classify the user image data as corresponding to the authorized user image data or the unauthorized user image data based at least in part on the amount of deviation.

19. The non-transitory computer-readable medium of claim 18, wherein the instructions further cause the one or more processors to:
execute the one or more vision-based machine-learning models further trained to classify the user image data as corresponding to the authorized user image data or the unauthorized user image data based at least in part on whether the amount of deviation satisfies a predetermined threshold.

20. The non-transitory computer-readable medium of claim 15, wherein the one or more vision-based machine-learning models comprises one or more of a multimodal language model (MLM) or a multimodal large language model (MLLM).
